(19) United States
(12) Patent Application Publication
(10) Pub. No.: US 2010/0045248 A1
(43) Pub. Date: Feb. 25, 2010

(54) Bi-directional Boost-Buck Voltage Converter

(75) Inventor: Stephen W. Hawley, Emerald Hills, CA (US)

Correspondence Address: ADVANCED ANALOGIC TECHNOLOGIES, 3230 Scott Blvd, Santa Clara, CA, 95054, US

(73) Assignee: ADVANCED ANALOGIC TECHNOLOGIES, INC., Santa Clara, CA (US)

(21) Appl. No.: 12/193,968

(22) Filed: Aug. 19, 2008

(51) Int. Cl. G05F 1/00

(52) U.S. Cl. 323/282

(57) ABSTRACT

A bi-directional Boost-Buck voltage converter includes a controller, a high-voltage capacitor, a lower-voltage battery, a resistive load, an inductor, and three or four switches, and provides a mechanism to efficiently provide power to the resistive load from the battery. It uses two configurations of the switches to configure the battery, the inductor, and the capacitor in a boost converter configuration to charge the capacitor from the battery. It uses two different configurations of the switches to configure the capacitor, the inductor, and the resistive load in a buck converter configuration to discharge the capacitor through the inductor and the resistive load.

### RELATED APPLICATIONS

This application is related to the subject matter of a concurrently filed application entitled “Control Method for DC/DC Converters and Switching Regulators.” The disclosure of the concurrently filed application is incorporated in this application by reference.

### BACKGROUND OF THE INVENTION

The availability of high brightness, high efficiency, full-spectrum white light Flash LEDs (FLEDs) allows portable systems designers to consider a single, integrated replacement for other light sources (such as Xenon flash and video lamp) that are required to support digital still photography and digital video. Simplified FLEDs drive requirements allow accurate control of output light levels and lighting period, allowing optimization of output light characteristics (color gamut, color temperature, etc.). This improved control opens the door for a single FLED light source to support short bursts (camera flash) and constant illumination (video illumination).

For adequate light output during a flash event, several FLEDs must be driven simultaneously. Based on existing FLED technology, digital still photography flash requires up to four (4) FLEDs at up to 3 A for a 50 ms time period. The instantaneous power required to drive the FLEDs can exceed 50 W for 50 ms. This greatly exceeds the peak power capability of portable energy reservoirs, commonly single cell Lithium-ion/polymer battery packs. This limitation is partially due to the high series impedance of the Lithium-ion/polymer battery pack (or equivalent series resistance, ESR), which can exceed 300 mΩ for an aged battery pack.

A low impedance supplemental energy reservoir (SupER) must be provided to sustain the flash event and eliminate battery voltage droop. The voltage droop is equal to the sum of the ESR and the parasitic circuit resistance, both multiplied by the current across the FLED resistive load. Parasitic resistance is found in circuit traces, connectors and package pins. To control costs and simplify product design, however, it is desirable to allow a reasonable level of parasitic resistance from the supplemental energy reservoir to the FLED load.

FLEDs may be driven in parallel or series arrangement, but series arrangement is more desirable. Series arrangement guarantees ideal current matching between the FLEDs and minimizes peak current—minimizing peak current maximizes operating efficiency by minimizing the effect of parasitic resistance and ESR. In series arrangement, the total FLED load voltage can reach 16V (assuming, for example, a 4V maximum forward voltage per each of four FLED devices).

“Dropout” occurs when the voltage of a supplemental energy reservoir equals the voltage of the FLED (load) it is driving. At dropout, the FLEDs will no longer function. Therefore, a high voltage supplemental energy reservoir (SupER) is desired to ensure significant operating voltage margin prior to “dropout.” The SupER should meet the following requirements:

Low internal impedance (low ESR)

High maximum voltage (˜50V)

Low cost

Small size

A 50V Aluminum-electrolytic (Al-el) capacitor satisfies the SupER requirements, for example. The smallest commonly available case size is approximately 5×11 mm (ØD×H)—which will fit into most low profile handheld products. Depending on output load requirements, power conversion efficiency and energy storage density, multiple parallel capacitors could also be used. Due to the low ESR of these Aluminum-electrolytic capacitors, they can be located at significant distances from the FLED load—simplifying product design while minimizing PCB layout cost and complexity.

### SUMMARY OF THE INVENTION

An embodiment of the present invention includes a bi-directional boost-buck voltage converter. The Boost-Buck converter provides a simple, low cost, high efficiency method to both pre-charge a high voltage, supplemental energy reservoir (a SupER) from a high capacity but low voltage battery pack, and to discharge the SupER into a load. Both pulsed cycle (as with a camera flash—one “charge” cycle, followed by a pause of relatively indeterminate length, and then one “discharge” cycle, with perhaps another pause) and continuous cycle (as with video lighting, for example—numerous cycles of “charge” and “discharge” following some orderly scheme) from the battery pack through the load are supported.

In addition to the SupER, the Boost-Buck converter also comprises an inductor, three or four switches (typically MOSFET devices but other types of devices may be used to suit the needs of differing applications) and a controller. The circuit utilizes these same energy storage and control elements during both charge and discharge periods for maximum performance, minimum cost, and minimum solution size.

In some applications, the switches may be embedded in and manufactured as part of the controller; in others, the switches may be external, and in others, some of the switches may be internal to the controller, while others are separate devices. External switches that are separate physical devices may have different characteristics than internal devices. The optimization of the system may depend on the frequency of the switching or the power requirements, for example.

The controller operates on instructions from an external container device, such as a portable phone or a digital camera, from where it gets one of a set of basic instructions. The set of instructions may include:
An instruction to execute an individual charge cycle
An instruction to execute an individual discharge cycle
An instruction to execute an individual charge cycle followed by an immediate execution of an individual discharge cycle, called “pulse” mode
An instruction to execute a succession of charge and discharge cycles (according to some external or internal parameters), called “continuous” mode
An instruction to turn the system off

Within these instructions and cycles, the controller manipulates the four switches to create connections to either charge the SupER from the battery (via the inductor) or discharge the SupER through the resistive load (also via the inductor.)

The controller can receive instruction from the containing device via a number of different methods, but one embodiment would use one serial connection to implement a small set of instructions. As an example, consider the case where the controller includes an enable pin EN. Toggling EN might initiate a charge/discharge cycle of the boost capacitor using pre-programmed parameters of allowable current, voltage, etc. Holding EN low might indicate continuous mode while the pin is held low. In the case of an LED being powered from the battery via the boost capacitor, this continuous mode would serve to provide near constant illumination (as seen to the human eye) as the LED quickly cycles on and off.

Two of the switches, S1 and S2, determine whether the circuit is operating in a charge cycle (charging the SupER from the battery) or a discharge cycle (discharging the SupER through the resistive load). In this summary, when S1 is ON and S2 is OFF, the battery is connected to the inductor and current is flowing from the battery, through the inductor, and to the SupER. The circuit is operating in its “charge” state, as energy is transferred from the battery to the SupER.

When S1 is OFF and S2 is ON, current flows in the opposite direction through the inductor: from the SupER, through the inductor, and then through the resistive load. In this configuration, the circuit is operating in its “discharge” state, as energy is transferred from the SupER to the resistive load.

In some applications, it may be possible to eliminate one of the specified switches, specifically S2. For example, if the forward voltage of the resistive load is greater than the output voltage of the battery, the resistive load will not draw any current while the SupER is charging during a charge cycle.

During a “charge” cycle, while S1 is ON and S2 is OFF, the controller manipulates switches S3 and S4 in order to use the battery and the inductor as a typical “boost” converter to apply a higher voltage to the SupER. It does this by alternately charging the inductor (switching S4 to ON and S3 to OFF, thereby connecting the inductor between the battery and ground and causing the inductor current to increase) and then discharging the inductor (switching S4 to OFF and S3 to ON, thereby causing the inductor current to flow into the SupER.) By repeatedly alternating the ON-OFF states of S3 and S4 during one charge cycle, the voltage of the SupER can be raised to a level above the voltage of the battery.

During a “discharge” cycle, while S1 is OFF and S2 is ON, the controller manipulates switches S3 and S4 in order in order to use the SupER, the inductor, and the resistive load as a typical “buck” converter, lowering the voltage that is supplied from the SupER to the resistive load. It does this by connecting the resistive load to one electrode of the inductor (via switch S2 that is switched ON) and then alternately connecting either the charged SupER to the other electrode of the inductor (by switching S3 to ON and S4 to OFF) or ground to the other electrode of the inductor (by switching S3 to OFF and S4 to ON.)

The invention may also optionally comprise an additional capacitor, called the bypass capacitor, wired in parallel to the resistive load. The bypass capacitor will reduce output ripple (a variation in voltage across the resistive load) and maintain current through the load during a discharge cycle. This feature may be desired in some applications.

The converter can be configured to provide current regulation in both the charge and discharge cycles. During the charge cycle, the goal is to limit inrush current from the battery, accomplished by charging the boost capacitor with constant input current. During the discharge cycle, the goal is to provide programmed current to the load.

In one embodiment, the converter may be configured to modulate the duty cycle of switches S3 and S4 using a variable ON time, constant OFF time control method. In this method, the time during which switch S3 is ON is considered to be the ON-time for both the charge and discharge cycles. The current through switch S3 is monitored using a resistive element. (In this or other cases, this resistive element is typically either the switch S3 itself or a resistor in series with switch S3.) During each switching cycle, switch S3 is turned off when this current reaches a predetermined limit. When switch S3 is turned OFF, switch S4 is turned ON for a fixed period of time.

In either the charge or discharge cycles, during the ON-time of switch S3, current increases linearly in the inductor, with slope determined by the following relationship:

dl_{L}/dt=V_{L}/L

where V_{L}=V_{IN} during the charge cycle (i.e., where the converter is operating as a boost converter) or V_{L}=V_{BOOST}−V_{LOAD} during the discharge cycle (i.e. where the converter is operating as a buck converter).

Other current control methods are possible, balancing the trade-off of time-to-charge the SupER with power loss through the ESR of the battery during a charge cycle, or more precisely or effectively managing the voltage across the resistive load during a discharge cycle. These methods include, but are not limited to, PWM (voltage mode, current mode), frequency modulation, constant OFF-time control, constant ON-time control, and hysteretic.

It is also possible to use the converter in “video mode”—a mode characterized by a number of repeating charge and discharge cycles, with the possibility of intervening quiet. Depending on the application requirements, there may also be more than one discharge cycle for each charge cycle executed by the controller. For example, the controller might execute a sequence of steps such as:

C (charge)-DC (discharge)-C-DC-C-DC-C-DC- . . .

Or a sequence such as

C-DC-DC-DC-C-DC-DC-DC-C-DC-DC-DC- . . .

In both examples above, “quiet” periods between each of the cycles might also be present, such as:

C-Q (quiet)-DC-Q-C-Q-DC-Q-C-Q-D-Q- . . .

The presence of quiet periods would be application dependent.

In such a mode, the load is driven by what becomes a pulse-width-modulated video (video PWM) technique, with the buck mode conduction period (discharge) divided by the total conduction period (charge plus discharge plus quiet) being equal to the video PWM “ON” interval of the load, or D_VIDEO=tDISCHARGE/[tDISCHARGE+tCHARGE+tQUIET]. In the case of an FLED string, for example, the human eye detects brightness as the average of the total light output, which is proportional to the video duty cycle (D_VIDEO) and programmed load current.

### BRIEF DESCRIPTION OF THE DRAWINGS

FIG. 1 is a schematic of a prior art single output synchronous boost converter.

FIG. 2 is a schematic of a prior art single output synchronous buck converter.

FIG. 3 is a schematic of a bi-directional boost-buck converter in accordance with one embodiment of the present invention.

FIG. 4 is a schematic of a bi-directional boost-buck converter with the optional bypass capacitor in accordance with one embodiment of the present invention.

FIG. 5 is a schematic of a bi-directional boost-buck converter with only three switches in accordance with one embodiment of the present invention.

FIG. 6 is a schematic of one preferred embodiment of the bi-directional boost-buck converter.

FIG. 7 is a simplified version of FIG. 6 that shows the bi-directional boost-buck converter of FIG. 6 operating during a charge cycle.

FIG. 8 is a simplified version of FIG. 6 that shows the bi-directional boost-buck converter of FIG. 6 operating during a discharge cycle.

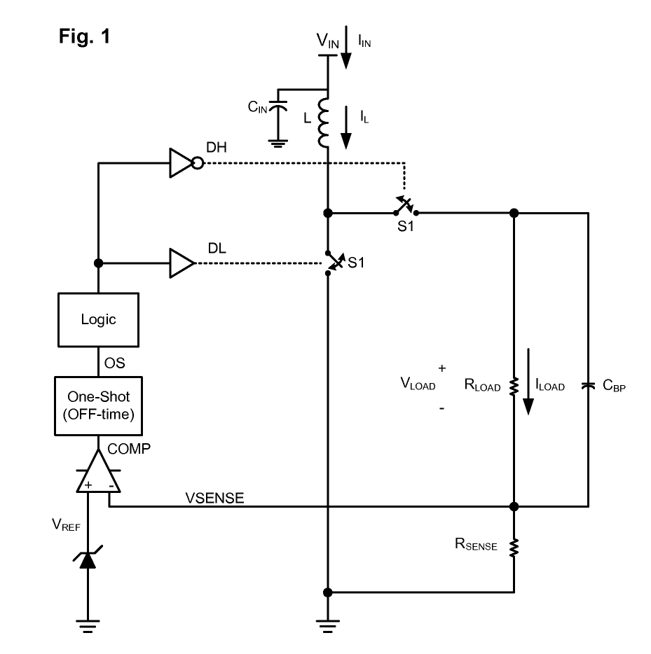

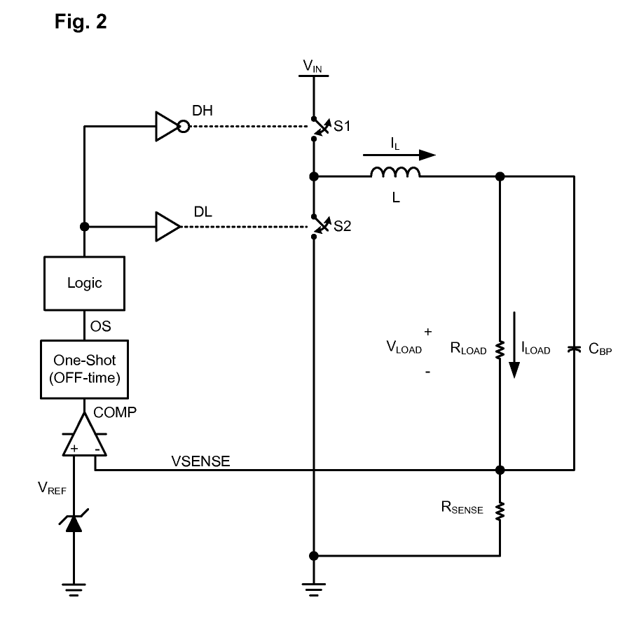

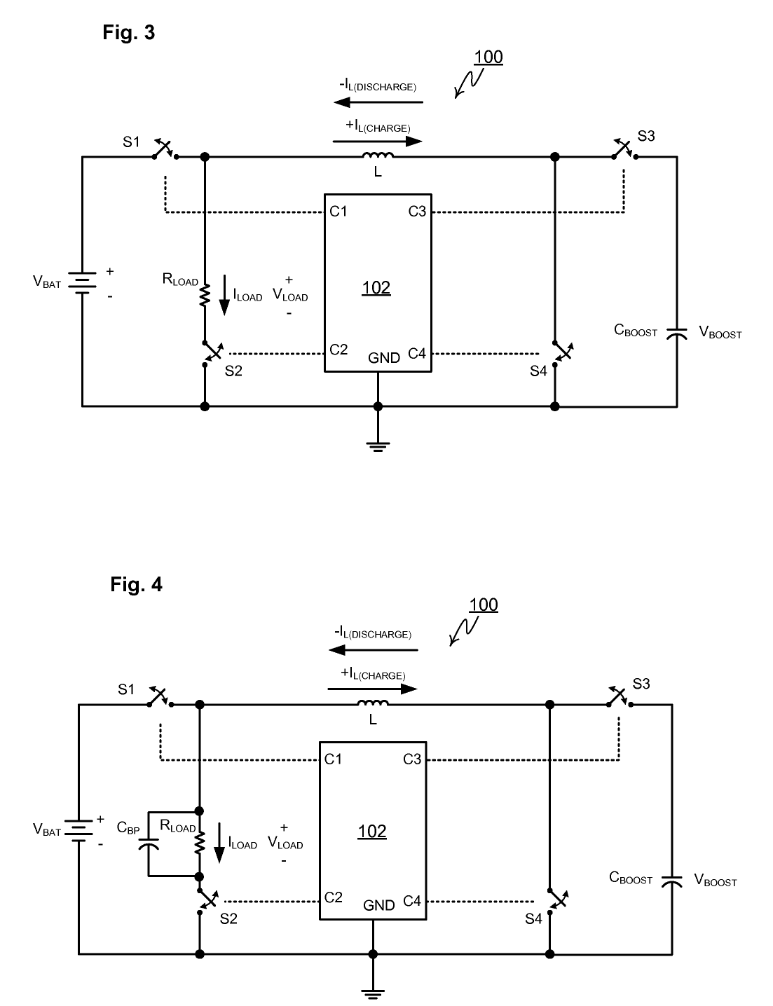

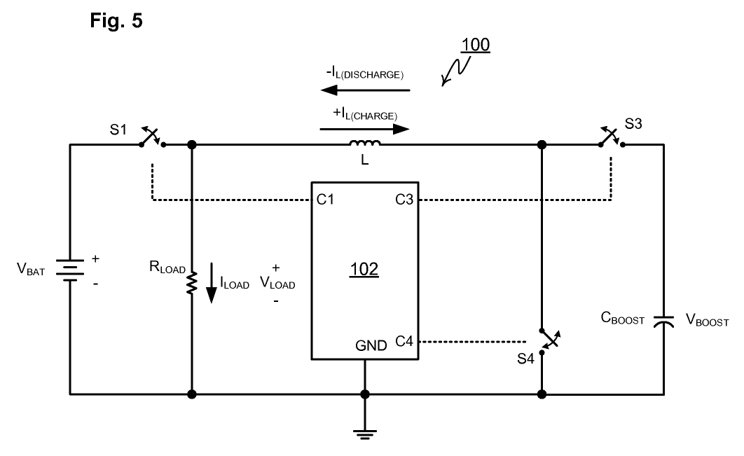

### DETAILED DESCRIPTION OF THE PREFERRED EMBODIMENTS

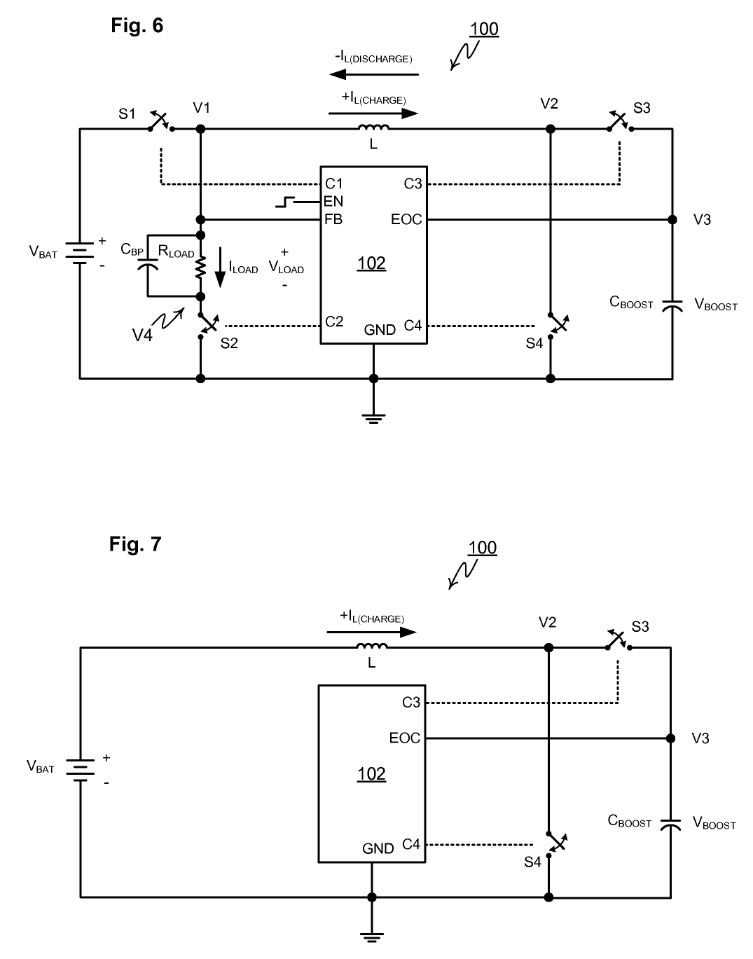

FIG. 6 shows one preferred embodiment of the present invention, generally designated 100. Converter 100 includes an integrated controller designated 102 and four MOSFET switches S1, S2, S3 and S4. Switch S1 is connected between the positive supply voltage of the battery pack and a node V1. A string of 4 FLEDs (represented in the drawing by the resistor R_{LOAD}) is connected in parallel with the bypass capacitor between the node V1 and the switch S2. The switch S2 is connected, in turn to ground.

An inductor L is connected between the node V1 and a node V2. Switch S4 connects the node V2 to ground. The switch S3 connects the node V2 to a node V3. The boost capacitor (C_{BOOST}) connects the node V3 to ground.

Each of the switches S1 through S4 is connected to and operated by controller 102. Controller 102 is also connected to monitor a feedback voltage V_{FB} at node V1 and an End-Of-Charge voltage V_{EOC} at node V3.

Converter 100 receives “commands” from its containing device (for example, a camera) and has two distinct operational phases: a charge cycle and a discharge cycle.

During the charge cycle, controller 102 turns switch S1 ON and turns switch S2 OFF. As shown in FIG. 7, this creates a boost topology where the boost capacitor C_{BOOST} functions as the “surrogate load.”

Next, the controller 102 turns switch S4 ON and turns switch S3 OFF in order to connect the inductor L in series between the input supply and ground, causing current to flow from the battery through the inductor to ground. This is the “ON time” period of the boost operating duty-cycle (D_BOOST), and current increases linearly in the inductor, its slope determined by the relationship: dl_{L}/dt=V_{IN}/L.

At a time determined by the controller, switch S4 is turned OFF and switch S3 is turned ON [the controller may terminate the “ON time” based on the current through switch S4—in which case, constant current from the input battery V_{IN} is possible]. This is the “OFF time” period of D_BOOST, and current decreases linearly in the inductor, its slope determined by the relationship: −dl_{L}/dt=V_{OUT}/L. Inductor current is directed into the boost capacitor C_{BOOST} during the Boost “OFF time”.

The process of turning switches S3 and S4 ON and OFF out of phase with each other continues until the End-Of-Charge voltage V_{EOC} threshold indicates to the controller 102 that the charge in the boost capacitor C_{BOOST} has reached the desired level and switch S1 is opened to maintain the voltage on C_{BOOST}. In some implementations, switching may also be terminated if charge cycle completes before End-Of-Charge voltage V_{EOC} that the charge in the boost capacitor C_{BOOST} has reached a desired level.

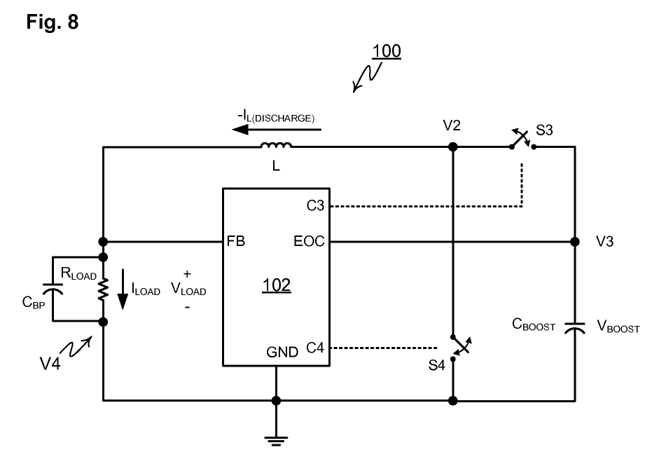

During the discharge cycle, controller 102 turns switch S1 OFF and turns switch S2 ON. As shown in FIG. 8, this creates a Buck topology where the boost capacitor C_{BOOST} functions as a surrogate input supply. The controller 102 then turns switch S3 ON and turns switch S4 OFF to connect the inductor L in series between the boost capacitor C_{BOOST} and the resistive load, causing current to flow from the boost capacitor through the inductor and load to ground. This is the “ON time” period of the Buck operating duty-cycle (D_BUCK), and current increases linearly in the inductor, its slope determined by the relationship: +dl_{L}/dt=(V_{N}−V_{LOAD})/L.

At a time determined by the controller, switch S3 is turned OFF and switch S4 is turned ON [the controller may terminate the “ON time” based on the current through switch S3—in which case, constant current into the Load is possible]. This is the “OFF time” period of D_BUCK, and current decreases linearly in the inductor, its slope determined by the relationship: −dl_{L}/dt=V_{LOAD}/L. Inductor current is directed into the Load during the Buck “OFF time”.

What is claimed is:

1. A bi-directional boost-buck converter circuit that comprises an inductor, a battery, a boost capacitor, three or more switches, a resistive load, and a controller, where the controller can perform a set of operations including:
manipulating the three or more switches during a charging cycle so that the boost capacitor is charged, from the battery via the inductor, to a voltage that is greater than the maximum voltage of the battery; and
manipulating the three or more switches during a discharging cycle so that the boost capacitor is discharged through the resistive load via the inductor.

2. A circuit as in claim 1 wherein the circuit comprises four or more switches.

3. A bi-directional boost-buck converter circuit as in claim 1 wherein the controller is configured to manipulate the three or more switches during the charging cycle so that a first electrode of the inductor is connected to the positive side of the battery and a second electrode of the inductor is alternately connected to either the boost capacitor or to ground; and wherein the controller is configured to manipulate the three or more switches during the discharging cycle so that the first electrode of the inductor is connected to the resistive load and the second electrode of the inductor is alternately connected to either the boost capacitor or to ground.

4. A circuit as in claim 3 wherein the circuit comprises four or more switches.

5. A circuit as in claim 3 or claim 4 wherein the controller is configured to manipulate the three or more switches during the charge cycle to alternately establish a first state in which the inductor is coupled between the battery and ground and a second state in which the inductor is coupled between the battery and the boost capacitor wherein the first state is terminated when the current passing from the battery through the inductor to ground has reached a predetermined level and wherein the second state has a predetermined duration.

6. A bi-directional boost-buck controller device that can perform a set of operations on three or more switches, an inductor, a battery, a boost capacitor, and a resistive load, the operations comprising:
manipulating the three or more switches during a charging cycle, so that the boost capacitor is charged from the battery via the inductor, to a voltage that is greater than the maximum voltage of the battery; and
manipulating the three or more switches during a discharging cycle so that the boost capacitor is discharged through the resistive load via the inductor.

7. A device as in claim 6 wherein the circuit comprises four or more switches.

8. A device as in claim 6 wherein the controller is configured to manipulate the three or more switches during the charging cycle so that a first electrode of the inductor is connected to the positive side of the battery and a second electrode of the inductor is alternately connected to either the boost capacitor or to ground; and wherein the controller is configured to manipulate the three or more switches during the discharging cycle so that the first electrode of the inductor is connected to the resistive load and the second electrode of the inductor is alternately connected to either the boost capacitor or to ground.

9. A device as in claim 8 wherein the circuit comprises four or more switches.

10. A device as in claim 8 or claim 9 wherein the controller is configured to manipulate the three or more switches during the charge cycle to alternately establish a first state in which the inductor is coupled between the battery and ground and a second state in which the inductor is coupled between the battery and the boost capacitor wherein the first state is terminated when the current passing from the battery through the inductor to ground has reached a predetermined level and wherein the second state has a predetermined duration.

11. A method for controlling a circuit, where the circuit comprises a battery, a resistive load, an inductor, three or more switches, and a boost capacitor, the method comprising:
manipulating the three or more switches during a charging cycle so that the boost capacitor is charged, from the battery via the inductor, to a voltage that is greater than the maximum voltage of the battery; and
manipulating the three or more switches during a discharging cycle, so that the boost capacitor is discharged through the resistive load via the inductor.

12. A method as in claim 11 wherein the circuit comprises four or more switches.

13. A method as in claim 11 wherein: the controller is configured to manipulate the three or more switches during the charging cycle so that a first electrode of the inductor is connected to the positive side of the battery and a second electrode of the inductor is alternately connected to either the boost capacitor or to ground; and wherein the controller is configured to manipulate the three or more switches during the discharging cycle so that the first electrode of the inductor is connected to the resistive load and the second electrode of the inductor is alternately connected to either the boost capacitor or to ground

14. A method as in claim 13 wherein the circuit comprises four or more switches.

15. A method as in claim 13 or claim 14 wherein the controller is configured to manipulate the three or more switches during the charge cycle to alternately establish a first state in which the inductor is coupled between the battery and ground and a second state in which the inductor is coupled between the battery and the boost capacitor wherein the first state is terminated when the current passing from the battery through the inductor to ground has reached a predetermined level and wherein the second state has a predetermined duration.
